(19) United States
(12) Patent Application Publication
(10) Pub. No.: US 2016/0074876 A1
(43) Pub. Date: Mar. 17, 2016

(54) Electrostatic Precipitator

(71) Applicant: University of Washington, Seattle, WA (US)

(72) Inventors: Andrei Afanasiev, Seattle, WA (US); Alexander V. Mamishev, Seattle, WA (US)

(21) Appl. No.: 14/851,492

(22) Filed: Sep. 11, 2015

Related U.S. Application Data
(60) Provisional application No. 62/049,293, filed on Sep. 11, 2014.

(51) Int. Cl. B03C 3/45

(52) U.S. Cl. CPC B03C 3/45

(57) ABSTRACT

An electrostatic precipitator may have different collecting and repelling electrodes surfaces. For example, a collecting electrode may have an internal conductive portion. A non-conductive or less conductive open cell foam covering may be applied to the conductive core of the collecting electrode. The foam may have cell sizes that vary within the volume of the foam or along the length of the foam. Accordingly the cell size of the foam near the leading, with respect to the direction of airflow, portion of the collector may be larger than the cell size of the foam nearer the trailing end of the collector and/or the cell size of the foam near the exterior of the collector may be larger than the cell size of the foam nearer to the interior of the collector.

### CROSS-REFERENCE TO RELATED APPLICATIONS

This application claims the benefit of pending U.S. Provisional Application 62/049,293 filed Sep. 11, 2014 (“Nonhomogeneous, open-cell foam coating for electrostatic air cleaner collector plates”), the disclosure of which is expressly incorporated herein by reference in its entirety.

### BACKGROUND OF THE INVENTION

1. Field of the Invention

The present technology relates generally to an electrostatic precipitator for cleaning gas flows. In particular, several embodiments are directed toward ELECTROSTATIC PRECIPITATORs having collection structures with open cells of varying sizes. Similar embodiments may also be useful for cleaning other types of gases industrial electrostatic precipitators, or other forms of electrostatic filtration.

2. Description of the Related Technology

The most common types of residential or commercial HVAC filters employ a fibrous filter media (made from polyester fibers, glass fibers or microfibers, etc.) placed substantially perpendicular to the airflow through which air may pass (e.g., an air conditioner filter, a HEPA filter, etc.) such that particles are removed from the air mechanically (coming into contact with one or more fibers and either adhering to or being blocked by the fibers); some of these filters are also electrostatically charged (either passively during use, or actively during manufacture) to increase the chances of particles coming into contact and staying adhered to the fibers.

Fibrous media filters typically have to be cleaned and/or replaced regularly due to an accumulation of particles. Furthermore, fibrous media filters are placed substantially perpendicular to the airflow, increasing airflow resistance and causing a significant static pressure differential across the filter, which increases as more particles accumulate or collect in the filter. Pressure drop across various components of an HVAC system is a constant concern for designers and operators of mechanical air systems, since it either slows the airflow or increases the amount of energy required to move the air through the system. Accordingly, there exists a need for an air filter capable of relatively long intervals between cleaning and/or replacement and a relatively low pressure drop across the filter after installation in an HVAC system.

Another form of air filter is known as an electrostatic precipitator. A conventional electrostatic precipitator includes one or more corona electrodes and one or more smooth metal electrode plates that are substantially parallel to the airflow. The corona electrodes produce a corona discharge that ionizes air molecules in an airflow received into the filter. The ionized air molecules impart a net charge to nearby particles (e.g., dust, dirt, contaminants etc.) in the airflow. The charged particles are subsequently electrostatically attracted to one of the electrode plates and thereby removed from the airflow as the air moves past the electrode plates. After a sufficient amount of air passes through the filter, the electrodes can accumulate a layer of particles and dust and eventually need to be cleaned. Cleaning intervals may vary from, for example, thirty minutes to several days. Further, since the particles are on an outer surface of the electrodes, they may become re-entrained in the airflow since a force of the airflow may exceed the electric force attracting the charged particles to the electrodes, especially if many particles agglomerate through attraction to each other, thereby reducing the net attraction to the collector plate. Such agglomeration and re-entrainment may require use of a media filter that is placed substantially perpendicular to the airflow, thereby increasing airflow resistance.

U.S. patent application Ser. No. 14/401,082 filed on 15 May 2013 and published 21 Nov. 2013, the disclosure of which is expressly incorporated by reference herein shows an electrostatic precipitator with improved performance. An article by Wen, T.; Wang, H.; Krichtafovitch, I.; and Mamishev, A. entitled Novel Electrodes of an Electrostatic Precipitator for Air Filtration, submitted to the Journal of Electrostatics, Nov. 12, 2014, the disclosure of which is expressly incorporated herein by reference, presents working principles of electrostatic precipitators and provides a discussion on the design concepts and schematics of a foam-covered electrostatic precipitator. The collector electrodes in the electrostatic precipitator described therein may be covered with porous foam. Electrostatic precipitators with foam-covered electrodes have improved capacity for particle collection, due in part, to the increased surface area of foam over metal collector plates and improved filtration efficiency because the effect of particle re-entrainment is reduced. Nevertheless, foam-covered electrostatic precipitators described in U.S. application Ser. No. 14/401,082 would have even better performance in some environments, particularly very dusty areas, if the collection capacity were increased thereby reducing the frequency of foam collector cleaning or replacement.

### SUMMARY OF THE INVENTION

It is an object of the invention to have an electrostatic precipitator suitable for very dusty areas.

It is an object to improve particle capture and retention, especially while filtering wide range of the particles: from micron size to sub-micron and ultra-fine (e.g.,) nanometer size particles.

It is an object to have collector structures capable of higher capacity particle collection useful for cleaning gas flows for use in heating, air-conditioning, and ventilation (HVAC) systems and other types of gas industrial electrostatic precipitators, or other forms of electrostatic filtration.

According to the invention an electrostatic precipitator may have an electrode assembly that includes one or more first electrodes and one or more second electrodes. The first electrodes may include an internal first conductive portion and an outer surface generally parallel with the air flow direction through the cavity. The first electrodes may have a first portion including a porous open-cell material that is generally parallel to with the air flow direction. The porous material may be engineered in a way that cells size varies through the length (i.e.: dimension) of the first electrode. The porous material may have greater cell size upwind and smaller cell size downwind of the air flow or greater cell size closer to internal first conductive portion the smaller cell size outward of the internal first conductive portion. The porous material may have a greater cell size downwind and smaller cell size upwind of the air flow. The porous material have a smaller cell size closer to internal first conductive portion and a greater cell size outward of the internal first conductive portion.

The invention may also be configured as a collector for use in an electrostatic precipitator having a porous material with an open cell structure mounted on a conductive core. A second porous material having an open cell structure mounted may be mounted on a conductive core. The first porous material may have a dominant cell size that is different than a dominant cell size of said second porous material. The first porous material and the second porous material may both mounted on a single conductive core, or on different conductive cores. The porous material may be orientated generally parallel with the air flow and thickness generally orthogonal to the air flow. The porous material may be engineered such that cell size varies through the length of the first electrode. The porous material may have a greater cell size upwind and smaller cell size downwind of the air flow. The porous material may have a greater cell size closer to the internal first conductive portion the smaller cell size outward of the internal first conductive portion. The porous material may have greater cell size downwind and smaller cell size upwind of the air flow. The porous material may have smaller cell size closer to internal first conductive portion the greater cell size outward of the internal first conductive portion. The porous material may have an open cell structure mounted on a conductive core, a second porous material having an open cell structure mounted on a conductive core where the first porous material has a dominant (i.e., predominant) cell size that is different than the dominant cell size of the second porous material. The first porous material and said second porous material may both be mounted on a single conductive core.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 shows a cross section of a nonhomogeneous, open-cell foam coating for electrostatic air cleaner collector plates.

### DETAILED DESCRIPTION OF A PREFERRED EMBODIMENT

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

The present technology relates generally to cleaning gas flows using electrostatic precipitators and associated systems and methods. In one aspect of the present technology, an electrostatic precipitator may include a housing having an inlet, an outlet, and a cavity there between. An electrode assembly may be positioned in the air filter between the inlet and the outlet. The electrode assembly may include a plurality of first electrodes (e.g., electrodes) and a plurality of second electrodes (e.g., repelling electrodes), both configured substantially parallel to the airflow.

In another aspect of the present technology, a method of filtering air may include creating an electric field using a plurality of corona electrodes arranged in an airflow path, such that the corona electrodes are positioned to ionize a portion of air molecules from the airflow. The method may also include applying a first electric potential at a plurality of first electrodes spaced apart from the corona electrodes, and receiving, at the first collection portion, particulate matter electrically coupled to the ionized air molecules.

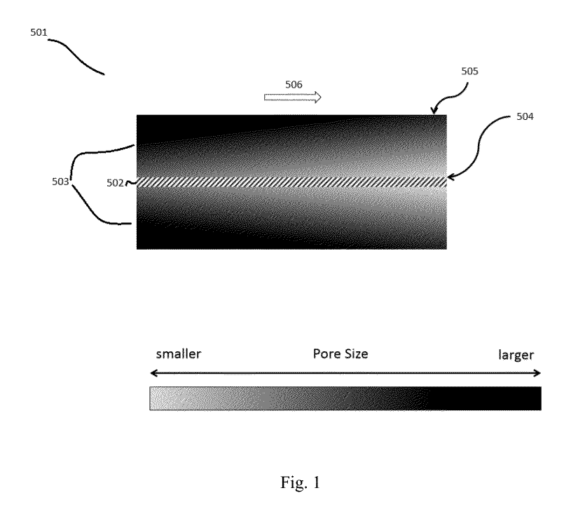

Referring to the FIG. 1 the foam coating on the first electrode (similar to the patent application 62/049,297, the disclosure of which is incorporated herein) is engineered such that the cell size on its outer surface is larger, as compared to the smaller cell size at its inner surface. Doing this can prevent small dust particles from settling on the outer surface of the foam and preventing bigger particles access to the inner volume of the foam. The smaller cell size foam will in turn help immobilize the smaller particles more effectively than the outer larger cell size foam. Such an arrangement can improve both the dust holding capacity of the foam covered first electrodes, as well as decrease re-entrainment of smaller dust particles into the airstream.

Furthermore, the outer surface cell size may also vary across the length of the collecting plate in the direction of the airflow. Since the mean size of the immobilized dust particles varies across the length of the first electrode (i.e. smaller particles will travel further inside the electrostatic precipitator, the foam cell size can be engineered to better accommodate the specific size of particles expected to be collected and immobilized at any point on the first electrode.

The outer surface may vary in only one of the directions (parallel or perpendicular to the airflow), and not the other of these respective directions. Moreover, the change in cell size may be in a gradient, continuously changing manner is indicated in the FIG. 1. In the FIG. 1 the proposed collector electrode 501 may include conductive plate 502 and open cell foam 503. Air flow direction is shown by the arrow 506. More dense color (505) shows foam cell with larger cell size while lighter color (504) shows smaller cell size.

Alternatively, the cell size may change based on a plurality of layers of foam, each having a different cell size, placed adjacent each other so as to collectively provide the change in cell size as discussed herein.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of electrostatic precipitation and particle collection have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context.

We claim:

1. An electrostatic precipitator, comprising:
an electrode assembly, wherein the electrode assembly includes a plurality of first electrodes and a plurality of second electrodes, wherein the first electrodes include an internal first conductive portion and an outer surface generally parallel with an airflow through a cavity of the electrode assembly; wherein the first electrodes further include a first portion comprising a porous open cell material, wherein the porous material has a length generally parallel with the airflow and a thickness generally orthogonal to the air flow, said porous material comprising cells that vary in size through the length of the first electrode.

2. An electrostatic precipitator according to claim 1, wherein the porous material has greater cell size upwind and smaller cell size downwind of the air flow.

3. An electrostatic precipitator according to claim 1, wherein the porous material has greater cell size closer to an internal first conductive portion and smaller cell size outward of the internal first conductive portion.

4. An electrostatic precipitator according to claim 1, wherein the porous material has greater cell size downwind and smaller cell size upwind of the air flow.

5. An electrostatic precipitator according to claim 1, wherein the porous material has smaller cell size closer to an internal first conductive portion and a greater cell size outward of the internal first conductive portion.

6. A collector for use in an electrostatic precipitator comprising:
a porous material having an open cell structure mounted on a conductive core;
a second porous material having an open cell structure mounted on a conductive core;
wherein the first porous material has a dominant cell size that is different than a dominant cell size of said second porous material.

7. A collector according to claim 6 wherein said first porous material and said second porous material are both mounted on a single conductive core.
